(19) United States
(12) Patent Application Publication
(10) Pub. No.: US 2025/0141330 A1
(43) Pub. Date: May 1, 2025

(54) EDDY CURRENT BRAKE

(71) Applicant: TELMA, Saint-Ouen-L'aumone (FR)

(72) Inventors: Mbarek Akafou, Les Mureaux (FR); Romuald Belance, Deuil La Barre (FR); Nicolas Quennet, Cormeilles En Parisis (FR); Rafik Lounis, CERGY (FR)

(21) Appl. No.: 18/928,506

(22) Filed: Oct. 28, 2024

(30) Foreign Application Priority Data
Oct. 30, 2023 (FR) 2311819

(51) Int. Cl. H02K 49/04

(52) U.S. Cl. CPC H02K 49/046

(57) ABSTRACT

The invention relates to an eddy current brake comprising a stator assembly (56, 76) and a rotor assembly able to pivot relative to the stator assembly about a rotation axis (X-X), the stator assembly (56) including an annular support (58) comprising at least one pole body (60) and at least one pole shoe (62), and wherein the stator assembly (56) includes a stainless-steel protective shield (64) fastened to the at least one pole shoe (62).

### CROSS-REFERENCE TO RELATED APPLICATIONS

This application claims the benefit of French Application Serial No. 2311819 filed Oct. 30, 2023, the entirety of which is hereby incorporated by reference.

### TECHNICAL FIELD OF THE INVENTION

The invention relates to an eddy current apparatus and in particular to an eddy current brake, also known as an electromagnetic retarder. Such electromagnetic retarders are used to supplement the braking systems of all types of vehicles, and notably of motorized land vehicles such as trains, heavy goods vehicles or even commercial vehicles, for which they are particularly advantageous.

### BACKGROUND OF THE INVENTION

Eddy current brakes comprise a stator assembly and a rotor assembly able to pivot relative to the stator assembly about a rotation axis. To reduce production costs, it is desirable to manufacture a part of the stator assembly from laminated iron or sintered material. The magnetic fields induced in the rotor during braking cause a heating of the rotor. When the rotor is hot, it emits infrared radiation toward the stator. This infrared radiation heats the stator. The stator is also heated by thermal convection. However, the laminated iron and the sintered materials have poor resistance to the high temperatures and, in particular to the high temperatures induced by the infrared radiation emitted by the rotor. This is because the sheets of laminated iron become detached from one another under the effect of the heat. As a result, the stator must be changed more frequently. It has a shorter lifespan. Moreover, it is not possible to drill a hole in a sintered material in a direction perpendicular to a plane parallel to the main faces of each sheet constituting the stack of laminated iron sheets.

### BRIEF SUMMARY OF THE INVENTION

It is desirable to allow a manufacturing of an eddy current brake having an annular support manufactured from laminated iron or sintered material which resists the infrared radiation emitted by the rotor during the braking, and which is accordingly more durable.

More generally, it is desirable to protect the windings regardless of the material used to make the annular support or the pole shoes.

### SUMMARY OF THE INVENTION

The present invention relates to an eddy current brake comprising a stator assembly and a rotor assembly able to pivot relative to the stator assembly about a rotation axis, the stator assembly including an annular support comprising at least one pole body and at least one pole shoe, and wherein the stator assembly includes a stainless-steel protective heat shield fastened to said at least one pole shoe.

The pole shoes are made of ferromagnetic mild steel. This material has a relatively high emissivity. Under the effects of infrared radiation, the pole shoes heat up. This heating induces a greater heating of the stator.

Advantageously, the protective heat shield protects the pole bodies and the field coils against the infrared radiation. The steel used is stainless steel.

When the pole shoes carry protective heat shields, they heat up less. As a result, the stator heats up less. Since the stator is subjected to lower temperatures, it has a longer lifespan.

The features described in the following paragraphs may optionally be implemented. They may be implemented independently of one another or in combination with one another:
said protective shield comprises a bottom wall and at least two side walls that are parallel to each other, said at least one pole shoe comprising at least two opposite side faces, and wherein the two side walls of the protective shield are mounted slidingly against the two opposite side faces of the at least one pole shoe.
at least one side wall of the protective shield and at least one side face of the at least one pole shoe comprise at least one threaded hole, and wherein the stator assembly comprises at least one fastening screw fastened in the at least one side wall of the protective shield and in the at least one side face of the at least one pole shoe.
the side faces of the at least one pole shoe comprise a projection and the side walls of the protective shield comprise a groove cooperating with the projection of the pole shoe.
the side walls of the protective shield comprise a projection and the side faces of the at least one pole shoe comprise a groove cooperating with the projection of the protective shield.
the annular support is made of laminated iron.
the annular support is made of sintered material.

### BRIEF DESCRIPTION OF THE DRAWINGS

FIG. 1 is a perspective view of an eddy current brake according to the invention;

FIG. 2 is a perspective view of a part of a stator assembly according to a first embodiment of the invention;

FIG. 3 is a perspective view of a part of a stator assembly according to a second embodiment of the invention.

### DETAILED DESCRIPTION OF THE INVENTION

The eddy current brake 2 according to the invention is described below in the preferred but non-limiting application thereof in an eddy current retarder.

The eddy current brake 2 can also be implemented in an electromagnetic retarder and generator assembly.

The eddy current brake 2 includes a rotor assembly 4 and a stator assembly 56. The rotor assembly is fastened by means of an intermediate part to a transmission shaft of a vehicle equipped with the retarder. The rotor assembly 4 includes an armature sleeve 8, a hub 10 and angled arms 12 which connect the armature sleeve to the hub. The hub is able to pivot about a rotation axis X-X.

The stator assembly 56 according to the first embodiment includes an annular support 58 fastened using appropriate means to the chassis of the vehicle or to the casing of the gearbox of the vehicle. The axis of the annular support 58 is coaxial with the rotation axis X-X.

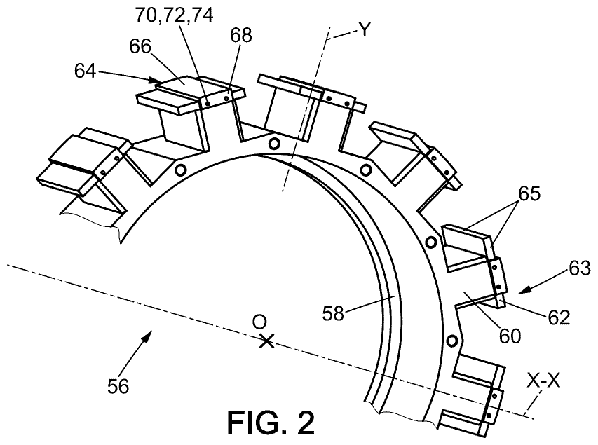

With reference to FIG. 2, the annular support 58 comprises peripheral pole bodies 60. The pole bodies 60 are distributed at regular intervals along a circle centered on a center O of the rotation axis X. The pole bodies have respective axes Y perpendicular to the rotation axis X-X.

The annular support 58 is made of laminated iron or sintered material.

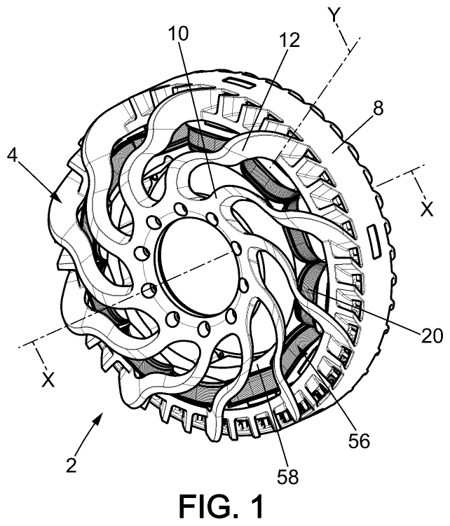

The stator assembly 56 further includes field coils 20 shown in FIG. 1. The field coils are arranged about the pole bodies 60. Each field coil 20 comprises a conductive wire wound about a pole body. The winding directions of the conductive wire alternate from one field coil to the next, so as to alternate the polarities of the field coils. Each field coil 20 is passed through by a pole body of axis Y.

With reference to FIG. 2, the stator assembly 56 also includes pole shoes 62.

The pole shoes 62 are used to immobilize the field coils 20 with respect to the pole bodies 60. The pole shoes also ensure a good distribution of the magnetic flux in the armature sleeve 8 and therefore an efficient generation of eddy currents.

The pole shoes 62 are also manufactured from laminated iron or sintered material or ferromagnetic mild steel. The pole shoes 62 include an upper face 63 and four side faces 65.

The stator assembly 56 further includes protective heat shields 64 fastened to the pole shoes. In the embodiment shown in FIG. 2, the protective heat shields 64 each comprise a bottom wall 66 and two side walls 68 that are parallel to each other. The two side walls 68 of the protective heat shields are mounted slidingly against and on the two opposite side faces 65 of the pole shoes. In particular, the two side walls 68 of the protective heat shields enclose the two opposite side faces 65 of the pole shoes.

In the embodiment illustrated in FIG. 2, the protective heat shield 64 is mounted slidingly in a direction perpendicular to the rotation axis X-X. In a variant, the protective heat shield 64 is mounted slidingly along the other two side faces 65, the protective shield 64 is then mounted slidingly in the direction of the rotation axis X-X.

Advantageously, the protective heat shield 64 is manufactured from stainless steel, and is therefore not affected by the infrared radiation coming from the rotor.

Advantageously, the protective heat shield 64 protects the annular support 58 from the infrared radiation emitted by the rotor.

The protective heat shield 64 can be fastened tightly without making a hole in the annular support.

In a variant, the side walls 68 of the protective heat shield may comprise two smooth holes 70 and the side faces 65 of the pole shoe may comprise two threaded holes 72. The stator assembly 56 comprises fastening screws 74 fastened in the side walls of the protective heat shields and in the side faces of the pole shoes.

This additional fastening using fastening screws can be carried out in an pole shoe made of laminated iron because the protective heat shield 64 is fastened without making holes in a direction perpendicular to the laminated iron sheets. In other words, the threaded holes are made in a direction belonging to a plane parallel to the main faces of the sheets constituting the stack of laminated sheets.

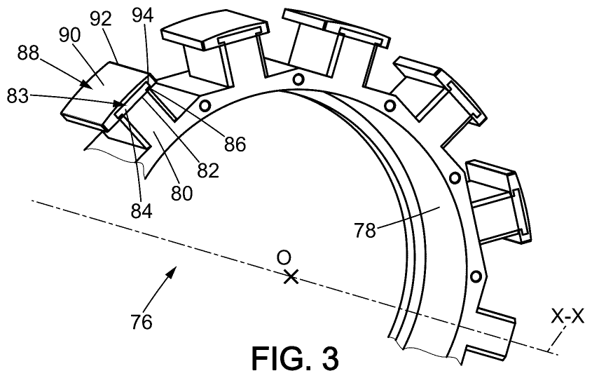

FIG. 3 shows a part of a stator assembly 76 according to a second embodiment. The stator assembly 76 includes an annular support 78. The annular support 78 includes pole bodies 80 and pole shoes 82 manufactured from laminated iron or sintered material.

In this embodiment, the pole shoes 82 comprise an upper face 83 and side faces 84. Two opposite side faces 84 of the pole shoes comprise a projection 86.

In the non-limiting embodiment illustrated, the projections 86 form rims which extend the upper face 83 of the pole shoes.

The stator assembly 76 further comprises protective heat shields 88 fastened to the pole shoes 82. The protective heat shields 88 have a bottom wall 90 and side walls 92. Each side wall 92 comprises a groove 94 designed to cooperate with a projection 86 of the side faces of the pole shoes.

The protective heat shields 88 are mounted slidingly and clamped against the side faces 84 of the pole bodies to ensure they do not move during operation of the eddy current brake.

In the embodiment illustrated in FIG. 3, the protective heat shields 88 are mounted slidingly in a direction parallel to the rotation axis X-X. The projections 86 are formed on the side faces of the pole shoes arranged opposite another pole shoe.

According to a variant which is not shown, the protective heat shields 88 are mounted slidingly in a direction perpendicular to the rotation axis X-X. The projections 86 are formed on the side faces of the pole shoes which are perpendicular to the rotation axis X-X.

According to another variant which is not shown, the side walls of the protective heat shield 88 comprise a projection and the side faces of the pole shoes comprise a groove cooperating with the projection of the protective heat shield.

In a variant, the pole shoes are manufactured from solid steel.

In a variant, the annular support and the pole bodies thereof are made of solid steel.

1. An eddy current brake (2) comprising a stator assembly (56, 76) and a rotor assembly (4) able to pivot relative to the stator assembly about a rotation axis (X-X), the stator assembly (56, 76) including an annular support (58, 78) comprising at least one pole body (60, 80) and at least one pole shoe (62, 82), and wherein the stator assembly (56, 76) includes a stainless-steel protective heat shield (64, 88) fastened to said at least one pole shoe (62, 82).

2. The eddy current brake (2) as claimed in claim 1, wherein said protective shield (64, 88) comprises a bottom wall (66, 90) and at least two side walls (68, 92) that are parallel to each other, said at least one pole shoe (62, 82) comprising at least two opposite side faces (65, 84), and wherein the two side walls (68, 92) of the protective shield are mounted slidingly against the two opposite side faces (65, 84) of the at least one pole shoe.

3. The eddy current brake (2) as claimed in claim 2, wherein at least one side wall (68) of the protective shield and at least one side face (65) of the at least one pole shoe comprise at least one threaded hole (70, 72), and wherein the stator assembly (56) comprises at least one fastening screw (74) fastened in the at least one side wall (68) of the protective shield and in the at least one side face (65) of the at least one pole shoe.

4. The eddy current brake (2) as claimed in claim 2, wherein the side faces (84) of the at least one pole shoe (82) comprise a projection (86) and the side walls (92) of the protective shield (88) comprise a groove (94) cooperating with the projection of the pole shoe.

5. The eddy current brake (2) as claimed in claim 2, wherein the side walls of the protective shield comprise a projection and the side faces of the at least one pole shoe comprise a groove cooperating with the projection of the protective shield.

6. The eddy current brake (2) as claimed in claim 1, wherein the annular support (58, 78) is made of laminated iron.

7. The eddy current brake (2) as claimed in claim 1, wherein the annular support (58, 78) is made of sintered material.
